(19) United States
(12) Patent Application Publication
(10) Pub. No.: US 2021/0080938 A1
(43) Pub. Date: Mar. 18, 2021

(54) SMART HISTORIAN FOR RIG EQUIPMENT

(71) Applicant: Schlumberger Technology Corporation, Sugar Land, TX (US)

(72) Inventors: Geir Kroslid, Kristiansand (NO); Johan Lindal Haug, Kristiansand (NO)

(21) Appl. No.: 16/573,015

(22) Filed: Sep. 17, 2019

(51) Int. Cl. G05B 23/02; E21B 41/00

(52) U.S. Cl. CPC G05B 23/024; E21B 41/0092

(57) ABSTRACT

A method for controlling a drilling rig based on a smart historian module. The smart historian module is configured to store equipment events, measurements or operating parameters as historic records. As the amount of information to be stored increases as the equipment on a rig is increasingly monitored, the smart historian examines the manner in which this increasing amount of information is to be stored and how it can be utilized in the drilling operation and maintenance of the equipment. The smart historian includes a fast loop component in the high frequency events environment to record the resultant measurement of key metrics and performance functions, hence reducing the size of recorded information, and enhancing the value of the dataset.

### BACKGROUND

Various components of a drilling rig control system may be disposed throughout a drilling rig in order to control various operations on the drilling rig. These components may control drilling equipment, monitor the performance of the drilling rig, and/or perform various maintenance operations with respect to the drilling rig.

### SUMMARY

In general, in one aspect, the invention relates to a method including generating, by a machine controller of a drilling rig control system and based on a first sampling rate, a plurality of sensor data associated with a machine component of a rig, receiving, via a control network by a historian module of the drilling rig control system and based on a second sampling rate, a first subset of the plurality of sensor data, wherein the second sampling rate is less than the first sampling rate, receiving, via the control network by a condition generator of the drilling rig control system and based on a third sampling rate, a second subset of the plurality of sensor data, wherein the second sampling rate is less than the third sampling rate, generating, by the condition generator, a condition indicator by at least analyzing the second subset of the plurality of sensor data, storing, by the historian module, the first subset of the plurality of sensor data and the condition indicator in a data repository of the drilling rig control system, and performing a management task of the rig based at least on the stored first subset of the plurality of sensor data and the stored condition indicator.

In general, in one aspect, the invention relates to a drilling rig control system. The drilling rig control system includes a machine controller configured to generate, based on a first sampling rate, a plurality of sensor data associated with a machine component of a rig, a historian module configured to receive, via a control network and based on a second sampling rate, a first subset of the plurality of sensor data, wherein the second sampling rate is less than the first sampling rate, and store the first subset of the plurality of sensor data and a condition indicator in a data repository, a condition generator comprising a computer processor and memory storing instructions, when executed by the computer processor, comprising functionality of receiving, via the control network and based on a third sampling rate, a second subset of the plurality of sensor data, wherein the second sampling rate is less than the third sampling rate, generating the condition indicator by at least analyzing the second subset of the plurality of sensor data, and providing the condition indicator to the historian module, a management module configured to perform a management task of the rig based at least on the stored first subset of the plurality of sensor data and the stored condition indicator, and the data repository for storing the first subset of the plurality of sensor data and a condition indicator.

In general, in one aspect, the invention relates to a non-transitory computer readable medium storing instructions. The instructions when executed comprising functionality for generating, by a machine controller of a drilling rig control system and based on a first sampling rate, a plurality of sensor data associated with a machine component of a rig, receiving, via a control network by a historian module of the drilling rig control system and based on a second sampling rate, a first subset of the plurality of sensor data, wherein the second sampling rate is less than the first sampling rate, receiving, via the control network by a condition generator of the drilling rig control system and based on a third sampling rate, a second subset of the plurality of sensor data, wherein the second sampling rate is less than the third sampling rate, generating, by the condition generator, a condition indicator by at least analyzing the second subset of the plurality of sensor data, storing, by the historian module, the first subset of the plurality of sensor data and the condition indicator in a data repository of the drilling rig control system, and performing a management task of the rig based at least on the stored first subset of the plurality of sensor data and the stored condition indicator.

Other aspects of the disclosure will be apparent from the following description and the appended claims.

### BRIEF DESCRIPTION OF DRAWINGS

FIGS. 1 and 2 show systems in accordance with one or more embodiments.

FIG. 3 shows a flowchart in accordance with one or more embodiments.

FIG. 4 shows an example in accordance with one or more embodiments.

FIGS. 5.1 and 5.2 show a computing system in accordance with one or more embodiments.

### DETAILED DESCRIPTION

Specific embodiments of the disclosure will now be described in detail with reference to the accompanying figures. Like elements in the various figures are denoted by like reference numerals for consistency.

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include a system and various methods for a smart historian. Throughout this disclosure, the term “historian” refers to a system component of a drilling rig control system. In one or more embodiments of the disclosure, the historian includes a software portion, a hardware portion, or a combination of software and hardware portions. In particular, the historian is configured to store equipment events, measurements or operating parameters as historic records, such as for troubleshooting of the rig control system. The amount of information to be stored increases as the equipment on a rig is increasingly monitored. In addition, as the needs of data analysis increase in order to seek performance optimization or prevent performance degradation of a drilling rig, the smart historian also examines the manner in which this increasing amount of information is to be stored and how it can be utilized in the drilling operation and maintenance of the equipment. Specifically, in one or more embodiments, a fast loop component is added in the high frequency events environment to record the resultant measurement of key metrics and performance functions back into the historian, hence reducing the size of recorded information, collection challenges and further reducing the complexity of data analytics. While the computation of key metrics and performance enhance the value of the dataset, it may also be advantageous to optionally reduce the size of the dataset if higher data sampling rates are needed to achieve the necessary accuracy for the condition indicators.

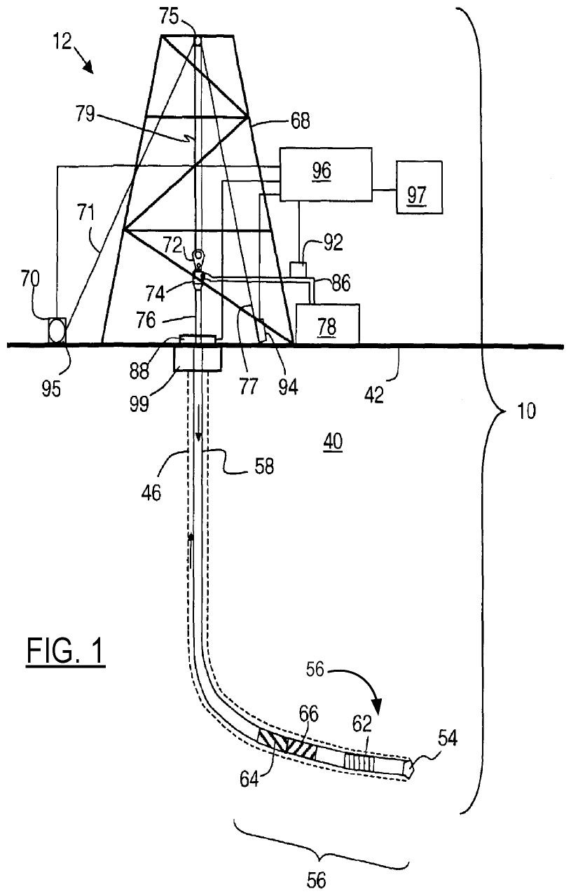

FIG. 1 shows a block diagram of a system in accordance with one or more embodiments. In one or more embodiments of the disclosure, one or more of the elements shown in FIG. 1 may be omitted, repeated, and/or substituted. Accordingly, embodiments of the disclosure should not be considered limited to the specific arrangements of modules shown in FIG. 1.

As shown in FIG. 1, a drilling system (10) includes a drill string (58) within borehole (46). Borehole (46) may be located in the earth (40) having a surface (42). Borehole (46) is shown being cut by the action of drill bit (54). Drill bit (54) may be disposed at the far end of the bottom hole assembly (56) that is attached to and forms the lower portion of drill string (58). Bottom hole assembly (56) may include a number of devices including various subassemblies. Measurement-while-drilling (MWD) subassemblies may be included in subassemblies (62). Examples of MWD measurements may include direction, inclination, survey data, downhole pressure (inside the drill pipe, and/or outside and/or annular pressure), resistivity, density, and porosity. Subassemblies (62) may also include a subassembly for measuring torque and weight on the drill bit (54). The signals from the subassemblies (62) may be processed in a processor (66). After processing, the information from processor (66) may be communicated to pulser assembly (64). Pulser assembly (64) may convert the information from the processor (66) into pressure pulses in the drilling fluid. The pressure pulses may be generated in a particular pattern which represents the data from the subassemblies (62). The pressure pulses may travel upwards though the drilling fluid in the central opening in the drill string and towards the surface system. The subassemblies in the bottom hole assembly (56) may further include a turbine or motor for providing power for rotating and steering drill bit (54).

The drilling rig (12) may include a derrick (68) and hoisting system, a rotating system, and/or a mud circulation system, for example. The hoisting system may suspend the drill string (58) and may include draw works (70), fast line (71), crown block (75), drilling line (79), traveling block and hook (72), swivel (74), and/or deadline (77). The rotating system may include a kelly (76), a rotary table (88), and/or engines (not shown). The rotating system may impart a rotational force on the drill string (58). Likewise, the embodiments shown in FIG. 1 may be applicable to top drive drilling arrangements as well. Although the drilling system (10) is shown being on land, those of skill in the art will recognize that the described embodiments are equally applicable to marine environments as well.

The mud circulation system may pump drilling fluid down an opening in the drill string. The drilling fluid may be called mud, which may be a mixture of water and/or diesel fuel, special clays, and/or other chemicals. The mud may be stored in mud pit (78). The mud may be drawn into mud pumps (not shown), which may pump the mud though stand pipe (86) and into the kelly (76) through swivel (74), which may include a rotating seal. Likewise, the described technologies may also be applicable to underbalanced drilling. If underbalanced drilling is used, at some point prior to entering the drill string, gas may be introduced into the mud using an injection system (not shown).

The mud may pass through drill string (58) and through drill bit (54). As the teeth of the drill bit (54) grind and gouge the earth formation into cuttings, the mud may be ejected out of openings or nozzles in the drill bit (54). These jets of mud may lift the cuttings off the bottom of the hole and away from the drill bit (54), and up towards the surface in the annular space between drill string (58) and the wall of borehole (46).

At the surface, the mud and cuttings may leave the well through a side outlet in blowout preventer (99) and through mud return line (not shown). Blowout preventer (99) comprises a pressure control device and a rotary seal. The mud return line may feed the mud into one or more separator (not shown) which may separate the mud from the cuttings. From the separator, the mud may be returned to mud pit (78) for storage and re-use.

Various sensors may be placed on the drilling rig (12) to take measurements of the drilling equipment. In particular, a hookload may be measured by hookload sensor (94) mounted on deadline (77), block position and the related block velocity may be measured by a block sensor (95) which may be part of the draw works (70). Surface torque may be measured by a sensor on the rotary table (88). Standpipe pressure may be measured by pressure sensor (92), located on standpipe (86). Signals from these measurements may be communicated to a surface processor (96) or other network elements (not shown) disposed around the drilling rig (12). In addition, mud pulses traveling up the drillstring may be detected by pressure sensor (92). For example, pressure sensor (92) may include a transducer that converts the mud pressure into electronic signals. The pressure sensor (92) may be connected to surface processor (96) that converts the signal from the pressure signal into digital form, stores and demodulates the digital signal into useable MWD data. According to various embodiments described above, surface processor (96) may be programmed to automatically detect one or more rig states based on the various input channels described. Processor (96) may be programmed, for example, to carry out an automated event detection as described above. Processor (96) may transmit a particular rig state and/or event detection information to user interface system (97) which may be designed to warn various drilling personnel of events occurring on the rig and/or suggest activity to the drilling personnel to avoid specific events.

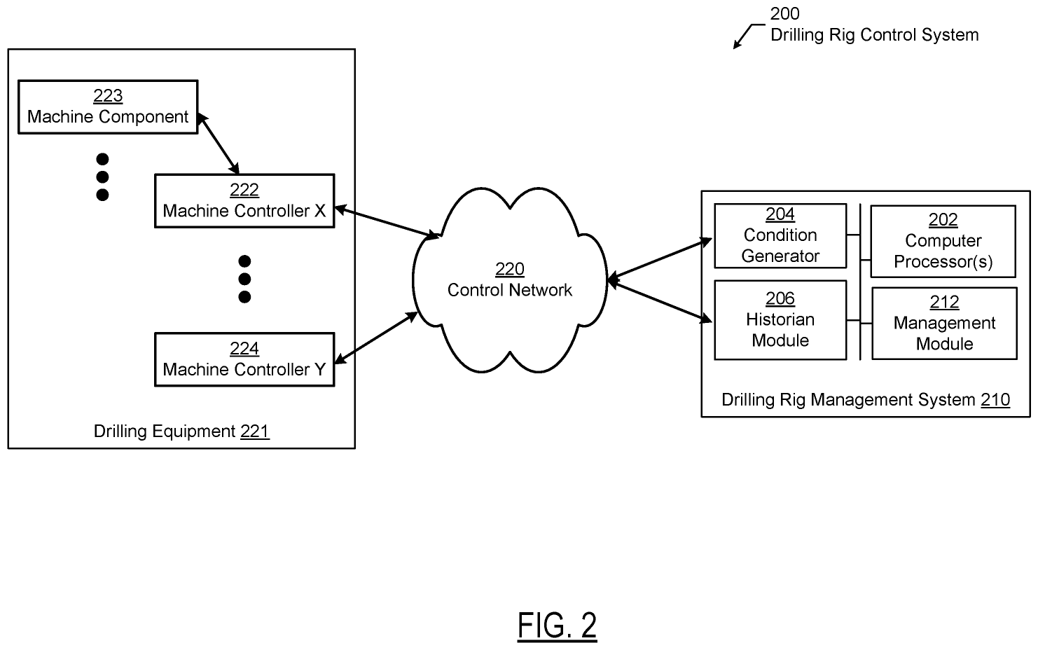

FIG. 2 shows a block diagram of a system in accordance with one or more embodiments. In one or more embodiments of the disclosure, one or more of the elements shown in FIG. 2 may be omitted, repeated, and/or substituted. Accordingly, embodiments of the disclosure should not be considered limited to the specific arrangements of modules shown in FIG. 2.

As shown in FIG. 2, a drilling rig control system (200) includes drilling equipment (221) having a number of machine components (e.g., machine component (223), etc.) controlled by corresponding machine controllers (e.g., machine controller X (222), machine controller Y (224), etc.). In one or more embodiments of the present disclosure, the machine components correspond to various drilling equipment of the drilling rig (12) depicted in FIG. 1 above, such as the deadline (77), draw works (70), rotary table (88), standpipe (86), drillstring (58), etc. As described above, the machine components include sensors, such as the hookload sensor (94), block sensor (95), pressure sensor (92), etc. Correspondingly, the machine controllers may include, for example, hardware and/or software with functionality to control one or more processes performed by such machine components based at least on the sensor data. In particular, the machine controllers may include ruggedized computer systems with functionality to withstand vibrations, extreme temperatures, wet conditions, and/or dusty conditions, for example, around the drilling rig (12). In one or more embodiments, each sensor may generate measurements on a periodic basis. The number of measurements generated per unit time is referred to as the sampling rate of the measurements, or the first sampling rate. In one or more embodiments, each machine controller is configured to generate, based on the first sampling rate, a stream of sensor data associated with the corresponding machine component. The sensor data may include the measurements directly, or may be derived from the measurements by the machine controller. For example, the sensor data may correspond to measurements of the hookload, block position and the related block velocity, surface torque, standpipe pressure, mud pulses, etc. described in reference to FIG. 1 above.

Further as shown in FIG. 2, the machine controllers are coupled to a drilling rig management system (210), which is a computing system configured to perform one or more management tasks of the drilling rig control system (200), via a control network (220). The control network (220) is a communication network for exchanging information among the machine controllers and the drilling rig management system (210). For example, the exchanged information may include the sensor data streams, control commands, or other information for control the drilling rig operations. In one or more embodiments, the drilling rig management system (210) includes a condition generator (204), a historian module (206), a management module (212), and computer processor(s) (202). The computer processor(s) (202) may correspond to the processor (66) depicted in FIG. 1 above that is configured to execute instructions for performing the functionalities of the condition generator (204), historian module (206), and management module (212).

In one or more embodiments, the historian module (206) is configured to receive, via the control network (220), a subset of the sensor data generated by a machine controller (e.g., machine controller X (222)). In one or more embodiments, the subset of the sensor data generated by a machine controller is received by the historian module (206) based on a second sampling rate that is less than the first sampling rate (i.e., the sampling rate of the measurements). Accordingly, the subset of the sensor data is stored in a data repository and is referred to as the first subset. For example, the second sample rate may be limited by one or more of storage capacity of the data repository, bandwidth of the control network (220), and processing power of the computer processor(s) (202) that are allocated to the historian module (206) for receiving the sensor data from the particular machine controller.

In one or more embodiments, the condition generator (204) is configured to receive, via the control network (220), another subset of the sensor data (referred to as the second subset) generated by the machine controller. In one or more embodiments, this second subset of the sensor data is received by the condition generator (204) based on a third sampling rate that exceeds the second sampling rate (i.e., the sampling rate of the historian module (206) receiving sensor data). In other words, the condition generator (204) is able to receive sensor data at an improved sampling rate than the historian module (206). Once received at the second sampling rate, the second subset of sensor data is analyzed by the condition generator (204) to generate a condition indicator that is provided to and stored by the historian module (206) to supplement the first subset of sensor data. For example, the condition indicator may be a value or a symbol that identifies a pre-determined characteristic or condition of the hookload, block position and the related block velocity, surface torque, standpipe pressure, mud pulses, etc. described in reference to FIG. 1 above. In one or more embodiments, the condition indicator includes a statistical measure of the second subset of sensor data. In one or more embodiments, in addition to the drilling equipment (221), pipe handling equipment (not shown) may also couple to the control network. In such embodiments, the drilling rig management system (210) may be augmented to manage such pipe handling equipment. For example, the condition indicators may also include a statistical measure of usage and performance data of such pipe handling equipment.

In one or more embodiment, the first subset and the second subset of sensor data are received from the same machine controller and overlap in time duration. Accordingly, the condition indicator is stored in the data repository in association with the first subset of sensor data. In one or more embodiments, the condition indicator represents the statistical measure of the sensor data of the overlapped time duration.

In one or more embodiments, the management module (212) is configured to perform a management task of the rig (e.g., rig (12) depicted in FIG. 1) based at least on the stored first subset of sensor data and the stored condition indicator. For example, the management task may include a diagnostic task, a maintenance task, a repair task, an upgrade task, etc. of various drilling equipment of the drilling rig (12) depicted in FIG. 1 above

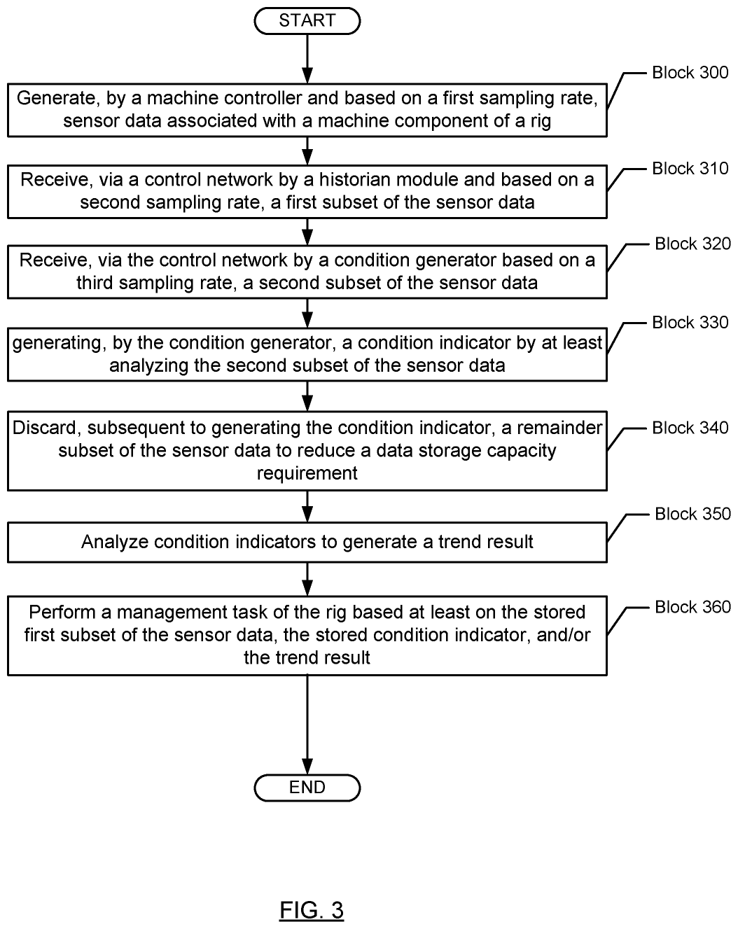

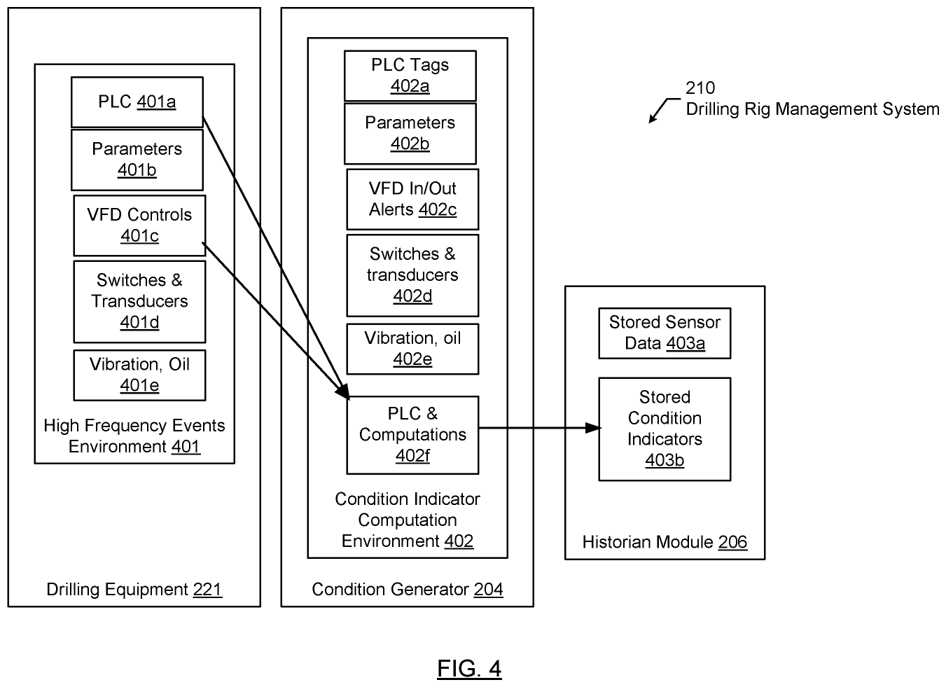

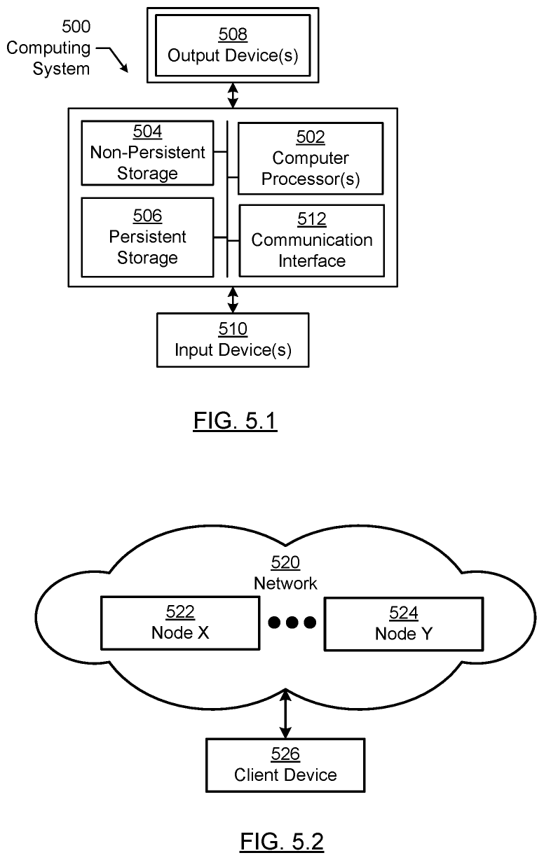

In one or more embodiments, the drilling rig management system (210) performs various functionalities described above using the method described in reference to FIG. 3 below. An example of the drilling rig management system (210) is described in reference to FIG. 4 below. In one or more embodiments, one or more of the machine controllers and the drilling rig management system (210) may be a computing system similar to the computing system (500) described in reference to FIGS. 5.1 and 5.2.

FIG. 3 shows a flowchart in accordance with one or more embodiments. In one or more embodiments, the method may be based on the systems depicted in FIGS. 1-2 above. One or more steps shown in FIG. 3 may be omitted, repeated, and/or performed in a different order among different embodiments of the invention. Accordingly, embodiments of the disclosure should not be considered limited to the specific number and arrangement of steps shown in FIG. 3.

Initially in Block 300, sensor data associated with a machine component of a rig is generated by a machine controller of a drilling rig control system. In one or more embodiments, the sensor data is generated based on a first sampling rate that is selected based on a sensor disposed on the machine component and/or a computing resource limitation of the machine controller.

In Block 310, a first subset of the sensor data is received, via a control network by a historian module of the drilling rig control system. In one or more embodiments, the first subset of the sensor data is received based on a second sampling rate that is less than the first sampling rate. In one or more embodiments, the second sampling rate is selected based on a computing resource limitation of the historian module. In one or more embodiments, the first subset of the sensor data is stored by the historian module in a data repository of the drilling rig control system.

In Block 320, a second subset of the sensor data is received, via the control network by a condition generator of the drilling rig control system. In one or more embodiments, the second subset of the sensor data is received based on a third sampling rate that exceeds the second sampling rate. In one or more embodiments, the third sampling rate is selected based on a computing resource limitation of the condition generator.

In Block 330, a condition indicator is generated by the condition generator. In one or more embodiments, the condition indicator is generated by at least analyzing the second subset of the sensor data received by the condition generator. In one or more embodiments, the condition indicator is sent to the historian module for storing with the first subset of the sensor data. In one or more embodiments, the condition generator and the first subset of the sensor data are embedded with time stamps for correlating to each other.

In Block 340, subsequent to generating the condition indicator, the second subset of the sensor data is discarded to reduce a data storage capacity requirement of the drilling rig control system. In contrast to the first subset of the sensor data, the second subset of the senor data is not stored in the data repository of the drilling rig control system.

In Block 350, a trend result is generated by analyzing a number of condition indicators that are generated at different time points over a time period. In one or more embodiments, the number of condition indicators form a utilization spectrum of the machine component over the time period. For example, the sensor data may correspond to position measurements of the aforementioned block position where the condition indicator may correspond to the amount of travel of a block of the draw works (70) depicted in FIG. 1 above. Accordingly, the trend result may indicate how much the available extent of travel is utilized by the block to perform the drilling rig operation. The utilized extent of travel at different time points may be aggregated to form a histogram, i.e., the utilization spectrum. For example, the trend result may indicate that over time, the utilized extent of travel is increasing as a percentage of total available travel. In an example scenario, analyzing the condition indicators over the time period includes comparing the utilization spectrum to a pre-determined threshold. In such example scenario, the trend result may identify a particular time point when the utilization spectrum intersects the pre-determined threshold. In other words, the utilized extent of travel increases over time and reaches the pre-determined threshold at the particular time point, which may indicate the need to perform a diagnostic task, maintenance task, repair task, and/or upgrade task of the draw works (70) depicted in FIG. 1 above. In another example, the sensor data may correspond to pressurization spectrums for standpipe and/or travel of axes of pipe handling machines. The travel may include both travel of the mechanism as well as the travel of the actuator. Accordingly, the trend result of such sensor data may also indicate the need to perform a diagnostic task, maintenance task, repair task, and/or upgrade task of the standpipe and/or pipe handling machines.

In one or more embodiments, the first subset of the sensor data corresponding to the particular time point may be retrieved by the historian module for further analysis to supplement the trend result. Accordingly, the trend result may be adjusted based on the corresponding first subset of the sensor data. For example, the aforementioned diagnostic task, maintenance task, repair task, and/or upgrade task may be adjusted based on the corresponding first subset of the sensor data.

In Block 360, a management task of the rig (e.g., the diagnostic task, maintenance task, repair task, and/or upgrade task) is performed based at least on one or more of the condition indicator, the trend result, and the supplemental first subset of the sensor data.

FIG. 4 shows an example in accordance with one or more embodiments. In one or more embodiments, the example may be based on the systems depicted in FIGS. 1-2 above and/or the method flowchart depicted in FIG. 3 above. In one or more embodiments, one or more of the elements shown in FIG. 4 may be omitted, repeated, and/or substituted. Accordingly, embodiments of the invention should not be considered limited to the specific arrangements of modules shown in FIG. 4.

As shown in FIG. 4, example details are included in the drilling equipment (221), condition generator (204), and historian module (206) of the drilling management system (200) depicted in FIG. 2 above. For example, the high frequency events environment (401) represents measurements being recorded at a high frequency (i.e., first sampling rate) of 5 millisecond (ms) per sample or less to generate the sensor data streams by the drilling equipment (221), such as from various machine controllers (401a) through (401e). The first subset of the sensor data is stored in the historian module (206) as the stored sensor data (403a), which is based on a lower frequency (i.e., second sampling rate) of 200 ms per sample, or approximately 40 times less than the first sampling rate. For example, approximately 3000 sensor data samples from the high frequency events environment (401) may be reduced into approximately 300 samples in the stored sensor data (403a) based on the second sampling rate.

In contrast, the condition indicator computation environment (402) represents generation of the condition indicators by the condition generator (204). For example, the sensor data from the high frequency events environment (401) (e.g., PLC (401a) and VFD controls (401c)) are used by the PLC & Computations block (402f) in the condition indicator computation environment (402) to compute condition indicators that are provided to the historian module (206) as the stored condition indicators (403b). For example, approximately 3000 sensor data samples from the high frequency events environment (401) may be reduced into approximately 1100 tags (i.e., an example form of condition indicator) based on an intermediate sampling rate of approximately 40 ms per sample (i.e., third sampling rate). The 1100 tags may include various portions (402a) through (402e) corresponding to the sources of the sensor data, i.e., machine controllers (401a) through (401e). Accordingly, the 1100 tags are sent to and stored by the historian module (206) as the stored condition indicators (403b).

Embodiments may be implemented on a computing system. Any combination of mobile, desktop, server, router, switch, embedded device, or other types of hardware may be used. For example, as shown in FIG. 5.1, the computing system (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), and numerous other elements and functionalities.

The computer processor(s) (502) may be an integrated circuit for processing instructions. For example, the computer processor(s) may be one or more cores or micro-cores of a processor. The computing system (500) may also include one or more input devices (510), such as a touchscreen, keyboard, mouse, microphone, touchpad, electronic pen, or any other type of input device.

The communication interface (512) may include an integrated circuit for connecting the computing system (500) to a network (not shown) (e.g., a local area network (LAN), a wide area network (WAN) such as the Internet, mobile network, or any other type of network) and/or to another device, such as another computing device.

Further, the computing system (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing systems exist, and the aforementioned input and output device(s) may take other forms.

Software instructions in the form of computer readable program code to perform embodiments of the disclosure may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the disclosure.

The computing system (500) in FIG. 5.1 may be connected to or be a part of a network. For example, as shown in FIG. 5.2, the network (520) may include multiple nodes (e.g., node X (522), node Y (524)). Each node may correspond to a computing system, such as the computing system shown in FIG. 5.1, or a group of nodes combined may correspond to the computing system shown in FIG. 5.1. By way of an example, embodiments of the disclosure may be implemented on a node of a distributed system that is connected to other nodes. By way of another example, embodiments of the disclosure may be implemented on a distributed computing system having multiple nodes, where each portion of the disclosure may be located on a different node within the distributed computing system. Further, one or more elements of the aforementioned computing system (500) may be located at a remote location and connected to the other elements over a network.

Although not shown in FIG. 5.2, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (522), node Y (524)) in the network (520) may be configured to provide services for a client device (526). For example, the nodes may be part of a cloud computing system. The nodes may include functionality to receive requests from the client device (526) and transmit responses to the client device (526). The client device (526) may be a computing system, such as the computing system shown in FIG. 5.1. Further, the client device (526) may include and/or perform all or a portion of one or more embodiments of the disclosure.

The computing system or group of computing systems described in FIGS. 5.1 and 5.2 may include functionality to perform a variety of operations disclosed herein. For example, the computing system(s) may perform communication between processes on the same or different systems. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

Based on the client-server networking model, sockets may serve as interfaces or communication channel end-points enabling bidirectional data transfer between processes on the same device. Foremost, following the client-server networking model, a server process (e.g., a process that provides data) may create a first socket object. Next, the server process binds the first socket object, thereby associating the first socket object with a unique name and/or address. After creating and binding the first socket object, the server process then waits and listens for incoming connection requests from one or more client processes (e.g., processes that seek data). At this point, when a client process wishes to obtain data from a server process, the client process starts by creating a second socket object. The client process then proceeds to generate a connection request that includes at least the second socket object and the unique name and/or address associated with the first socket object. The client process then transmits the connection request to the server process. Depending on availability, the server process may accept the connection request, establishing a communication channel with the client process, or the server process, busy in handling other operations, may queue the connection request in a buffer until the server process is ready. An established connection informs the client process that communications may commence. In response, the client process may generate a data request specifying the data that the client process wishes to obtain. The data request is subsequently transmitted to the server process. Upon receiving the data request, the server process analyzes the request and gathers the requested data. Finally, the server process then generates a reply including at least the requested data and transmits the reply to the client process. The data may be transferred, more commonly, as datagrams or a stream of characters (e.g., bytes).

Shared memory refers to the allocation of virtual memory space in order to substantiate a mechanism for which data may be communicated and/or accessed by multiple processes. In implementing shared memory, an initializing process first creates a shareable segment in persistent or non-persistent storage. Post creation, the initializing process then mounts the shareable segment, subsequently mapping the shareable segment into the address space associated with the initializing process. Following the mounting, the initializing process proceeds to identify and grant access permission to one or more authorized processes that may also write and read data to and from the shareable segment. Changes made to the data in the shareable segment by one process may immediately affect other processes, which are also linked to the shareable segment. Further, when one of the authorized processes accesses the shareable segment, the shareable segment maps to the address space of that authorized process. Often, one authorized process may mount the shareable segment, other than the initializing process, at any given time.

Other techniques may be used to share data, such as the various data described in the present application, between processes without departing from the scope of the disclosure. The processes may be part of the same or different application and may execute on the same or different computing system.

Rather than or in addition to sharing data between processes, the computing system performing one or more embodiments of the disclosure may include functionality to receive data from a user. For example, in one or more embodiments, a user may submit data via a graphical user interface (GUI) on the user device. Data may be submitted via the graphical user interface by a user selecting one or more graphical user interface widgets or inserting text and other data into graphical user interface widgets using a touchpad, a keyboard, a mouse, or any other input device. In response to selecting a particular item, information regarding the particular item may be obtained from persistent or non-persistent storage by the computer processor. Upon selection of the item by the user, the contents of the obtained data regarding the particular item may be displayed on the user device in response to the user's selection.

By way of another example, a request to obtain data regarding the particular item may be sent to a server operatively connected to the user device through a network. For example, the user may select a uniform resource locator (URL) link within a web client of the user device, thereby initiating a Hypertext Transfer Protocol (HTTP) or other protocol request being sent to the network host associated with the URL. In response to the request, the server may extract the data regarding the particular selected item and send the data to the device that initiated the request. Once the user device has received the data regarding the particular item, the contents of the received data regarding the particular item may be displayed on the user device in response to the user's selection. Further to the above example, the data received from the server after selecting the URL link may provide a web page in Hyper Text Markup Language (HTML) that may be rendered by the web client and displayed on the user device.

Once data is obtained, such as by using techniques described above or from storage, the computing system, in performing one or more embodiments of the disclosure, may extract one or more data items from the obtained data. For example, the extraction may be performed as follows by the computing system (500) in FIG. 5.1. First, the organizing pattern (e.g., grammar, schema, layout) of the data is determined, which may be based on one or more of the following: position (e.g., bit or column position, Nth token in a data stream, etc.), attribute (where the attribute is associated with one or more values), or a hierarchical/tree structure (consisting of layers of nodes at different levels of detail—such as in nested packet headers or nested document sections). Then, the raw, unprocessed stream of data symbols is parsed, in the context of the organizing pattern, into a stream (or layered structure) of tokens (where each token may have an associated token “type”).

Next, extraction criteria are used to extract one or more data items from the token stream or structure, where the extraction criteria are processed according to the organizing pattern to extract one or more tokens (or nodes from a layered structure). For position-based data, the token(s) at the position(s) identified by the extraction criteria are extracted. For attribute/value-based data, the token(s) and/or node(s) associated with the attribute(s) satisfying the extraction criteria are extracted. For hierarchical/layered data, the token(s) associated with the node(s) matching the extraction criteria are extracted. The extraction criteria may be as simple as an identifier string or may be a query presented to a structured data repository (where the data repository may be organized according to a database schema or data format, such as XML).

The extracted data may be used for further processing by the computing system. For example, the computing system of FIG. 5.1, while performing one or more embodiments of the disclosure, may perform data comparison. Data comparison may be used to compare two or more data values (e.g., A, B). For example, one or more embodiments may determine whether A>B, A=B, A!=B, A<B, etc. The comparison may be performed by submitting A, B, and an opcode specifying an operation related to the comparison into an arithmetic logic unit (ALU) (i.e., circuitry that performs arithmetic and/or bitwise logical operations on the two data values). The ALU outputs the numerical result of the operation and/or one or more status flags related to the numerical result. For example, the status flags may indicate whether the numerical result is a positive number, a negative number, zero, etc. By selecting the proper opcode and then reading the numerical results and/or status flags, the comparison may be executed. For example, in order to determine if A>B, B may be subtracted from A (i.e., A−B), and the status flags may be read to determine if the result is positive (i.e., if A>B, then A−B>0). In one or more embodiments, B may be considered a threshold, and A is deemed to satisfy the threshold if A=B or if A>B, as determined using the ALU. In one or more embodiments of the disclosure, A and B may be vectors, and comparing A with B includes comparing the first element of vector A with the first element of vector B, the second element of vector A with the second element of vector B, etc. In one or more embodiments, if A and B are strings, the binary values of the strings may be compared.

The computing system in FIG. 5.1 may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The computing system of FIG. 5.1 may include functionality to present raw and/or processed data, such as results of comparisons and other processing. For example, presenting data may be accomplished through various presenting methods. Specifically, data may be presented through a user interface provided by a computing device. The user interface may include a GUI that displays information on a display device, such as a computer monitor or a touchscreen on a handheld computer device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

For example, a GUI may first obtain a notification from a software application requesting that a particular data object be presented within the GUI. Next, the GUI may determine a data object type associated with the particular data object, e.g., by obtaining data from a data attribute within the data object that identifies the data object type. Then, the GUI may determine any rules designated for displaying that data object type, e.g., rules specified by a software framework for a data object class or according to any local parameters defined by the GUI for presenting that data object type. Finally, the GUI may obtain data values from the particular data object and render a visual representation of the data values within a display device according to the designated rules for that data object type.

Data may also be presented through various audio methods. In particular, data may be rendered into an audio format and presented as sound through one or more speakers operably connected to a computing device.

Data may also be presented to a user through haptic methods. For example, haptic methods may include vibrations or other physical signals generated by the computing system. For example, data may be presented to a user using a vibration generated by a handheld computer device with a predefined duration and intensity of the vibration to communicate the data.

The above description of functions presents only a few examples of functions performed by the computing system of FIG. 5.1 and the nodes and/or client device in FIG. 5.2. Other functions may be performed using one or more embodiments of the disclosure.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A method, comprising:
generating, by a machine controller of a drilling rig control system and based on a first sampling rate, a plurality of sensor data associated with a machine component of a rig;
receiving, via a control network by a historian module of the drilling rig control system and based on a second sampling rate, a first subset of the plurality of sensor data, wherein the second sampling rate is less than the first sampling rate;
receiving, via the control network by a condition generator of the drilling rig control system and based on a third sampling rate, a second subset of the plurality of sensor data, wherein the second sampling rate is less than the third sampling rate;
generating, by the condition generator, a condition indicator by at least analyzing the second subset of the plurality of sensor data;
storing, by the historian module, the first subset of the plurality of sensor data and the condition indicator in a data repository of the drilling rig control system; and
performing a management task of the rig based at least on the stored first subset of the plurality of sensor data and the stored condition indicator.

2. The method of claim 1, further comprising:
discarding, subsequent to generating the condition indicator, the second subset of the plurality of sensor data to reduce a data storage capacity requirement of the drilling rig control system.

3. The method of claim 1, further comprising:
selecting the first sampling rate based on a sensor disposed on the machine component and a first computing resource limitation of the machine controller.

4. The method of claim 1, further comprising:
selecting the second sampling rate based on a second computing resource limitation of the historian module.

5. The method of claim 1, further comprising:
selecting the third sampling rate based on a third computing resource limitation of the condition generator.

6. The method of claim 1, further comprising:
analyzing a plurality of condition indicators to generate a trend result, wherein the plurality of condition indicators are generated by the condition generator at a plurality of time points, the plurality of time points comprising a first time point when the condition indicator is generated,
wherein the management task is performed based on the trend result.

7. The method of claim 6, further comprising:
analyzing the trend result to identify a second time point, wherein the second time point corresponds to when the first subset of the plurality of sensor data is stored,
retrieving, based on the second time point and from the data repository, the first subset,
wherein the management task is performed further based on the first subset.

8. The method of claim 7,
wherein the plurality of condition indicators form a utilization spectrum of the machine component,
wherein analyzing the plurality of condition indicators comprises comparing the utilization spectrum to a pre-determined threshold, and
wherein the trend result identifies the second time point as when the utilization spectrum intersects the pre-determined threshold.

9. A drilling rig control system, comprising:
a machine controller configured to generate, based on a first sampling rate, a plurality of sensor data associated with a machine component of a rig;
a historian module configured to:
receive, via a control network and based on a second sampling rate, a first subset of the plurality of sensor data, wherein the second sampling rate is less than the first sampling rate; and
store the first subset of the plurality of sensor data and a condition indicator in a data repository;
a condition generator comprising:
a computer processor; and
memory storing instructions, when executed by the computer processor, comprising functionality of:
receiving, via the control network and based on a third sampling rate, a second subset of the plurality of sensor data, wherein the second sampling rate is less than the third sampling rate;
generating the condition indicator by at least analyzing the second subset of the plurality of sensor data; and
providing the condition indicator to the historian module;
a management module configured to perform a management task of the rig based at least on the stored first subset of the plurality of sensor data and the stored condition indicator; and
the data repository for storing the first subset of the plurality of sensor data and a condition indicator.

10. The drilling rig control system of claim 9, the instructions, when executed by the computer processor, further comprising functionality of:
discarding, subsequent to generating the condition indicator, the second subset of the plurality of sensor data to reduce a data storage capacity requirement of the drilling rig control system.

11. The drilling rig control system of claim 9,
wherein the first sampling rate is selected based on a sensor disposed on the machine component and a first computing resource limitation of the machine controller,
wherein the second sampling rate is selected based on a second computing resource limitation of the historian module, and
wherein the third sampling rate is selected based on a third computing resource limitation of the condition generator.

12. The drilling rig control system of claim 9, the management module further configured to:
analyze a plurality of condition indicators to generate a trend result, wherein the plurality of condition indicators are generated by the condition generator at a plurality of time points, the plurality of time points comprising a first time point when the condition indicator is generated,
wherein the management task is performed based on the trend result.

13. The drilling rig control system of claim 12, the management module further configured to:
analyzing the trend result to identify a second time point, wherein the second time point corresponds to when the first subset of the plurality of sensor data is stored,
retrieving, based on the second time point and from the data repository, the first subset,
wherein the management task is performed further based on the first subset.

14. The drilling rig control system of claim 13,
wherein the plurality of condition indicators form a utilization spectrum of the machine component,
wherein analyzing the plurality of condition indicators comprises comparing the utilization spectrum to a pre-determined threshold, and
wherein the trend result identifies the second time point as when the utilization spectrum intersects the pre-determined threshold.

15. A non-transitory computer readable medium storing instructions, the instructions when executed comprising functionality for:
generating, by a machine controller of a drilling rig control system and based on a first sampling rate, a plurality of sensor data associated with a machine component of a rig;
receiving, via a control network by a historian module of the drilling rig control system and based on a second sampling rate, a first subset of the plurality of sensor data, wherein the second sampling rate is less than the first sampling rate;
receiving, via the control network by a condition generator of the drilling rig control system and based on a third sampling rate, a second subset of the plurality of sensor data, wherein the second sampling rate is less than the third sampling rate;
generating, by the condition generator, a condition indicator by at least analyzing the second subset of the plurality of sensor data;
storing, by the historian module, the first subset of the plurality of sensor data and the condition indicator in a data repository of the drilling rig control system; and
performing a management task of the rig based at least on the stored first subset of the plurality of sensor data and the stored condition indicator.

16. The non-transitory computer readable medium of claim 15, the instructions when executed further comprising functionality for:
discarding, subsequent to generating the condition indicator, the second subset of the plurality of sensor data to reduce a data storage capacity requirement of the drilling rig control system.

17. The non-transitory computer readable medium of claim 15,
wherein the first sampling rate is selected based on a sensor disposed on the machine component and a first computing resource limitation of the machine controller,
wherein the second sampling rate is selected based on a second computing resource limitation of the historian module, and
wherein the third sampling rate is selected based on a third computing resource limitation of the condition generator.

18. The non-transitory computer readable medium of claim 15, the instructions when executed further comprising functionality for:
analyzing a plurality of condition indicators to generate a trend result, wherein the plurality of condition indicators are generated by the condition generator at a plurality of time points, the plurality of time points comprising a first time point when the condition indicator is generated,
wherein the management task is performed based on the trend result.

19. The non-transitory computer readable medium of claim 6, the instructions when executed further comprising functionality for:
analyzing the trend result to identify a second time point, wherein the second time point corresponds to when the first subset of the plurality of sensor data is stored,
retrieving, based on the second time point and from the data repository, the first subset,
wherein the management task is performed further based on the first subset.

20. The non-transitory computer readable medium of claim 19,
wherein the plurality of condition indicators form a utilization spectrum of the machine component,
wherein analyzing the plurality of condition indicators comprises comparing the utilization spectrum to a pre-determined threshold, and
wherein the trend result identifies the second time point as when the utilization spectrum intersects the pre-determined threshold.
